(19) United States
(12) Patent Application Publication
(10) Pub. No.: US 2008/0099396 A1
(43) Pub. Date: May 1, 2008

(54) Device and Method for Purifying Waste Water

(75) Inventors: Uwe Rother, Ullersdorf (DE); Frank Wiemeyer, Schwedt (DE); Eberhard Kopp, Schwedt (DE); Christoph Gundlach, Rostock (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignees: Kowitec Ingenieurgesellschaft Fuer Wassertechnik MBH, Rostock (DE); Meri Entsorgungstechnik fuer die Papierindustrie GmbH, Munich (DE)

(21) Appl. No.: 11/664,029

(22) PCT Filed: Sep. 28, 2005
(86) PCT No.: PCT/EP05/54876

§ 371 Date: Oct. 16, 2007

(30) Foreign Application Priority Data
Sep. 28, 2004 (DE) 10 2004 047 010.3

(51) Int. Cl. C02F 1/00; C02F 1/52; C02F 1/54; C02F 3/00

(52) U.S. Cl. 210/609; 210/705; 210/739; 210/740; 210/741; 210/742; 210/743; 210/744; 210/746; 210/87; 210/88

(57) ABSTRACT

The invention relates to a device for purifying water, in particular for the continuous purification of water in the paper industry, said device comprising at least one supply line and at least one drain line for the water. The device also comprises a compression device for at least one sub-stream of the water, an injection device for injecting at least one gas and an expansion device for expanding at least one sub-stream of the water. In addition, the device comprises a unit for separating different phases of the water for purification. The device is characterized by a control system, which detects at least one parameter of the water and controls at least the addition of at least one additive in accordance with the process parameter.

### CROSS-REFERENCE TO RELATED APPLICATIONS

This application is a National Stage of International Application No. PCT/EP2005/054876, filed Sep. 28, 2005, and which claims the benefit of German Patent Application No. 10 2004 047 010.3, filed Sep. 28, 2004. The disclosures of the above applications are incorporated herein by reference.

### FIELD

The present invention relates to an apparatus and to a method for the purification of water, in particular for the continuous purification of water in the paper industry.

### BACKGROUND

The statements in this section merely provide background information related to the present disclosure and may not constitute prior art.

Such methods for the purification of in particular industrial waste waters are known in the prior art.

The purification of waters, in particular in industry, is necessary, on the one hand, so that such waters can be introduced into the public sewer system and are below the values prescribed by law with respect to the constituents. Furthermore, the highest possible return quota of the waters used, in particular of process water, into the production process, is also wanted. Purification stages are used for this purpose with which the water quality is improved such that a return into the production process is possible and the consumption of water can be reduced with respect to the quantity of products manufactured.

In accordance with the prior art, the desired purification effect can take place by, for example, mechanical, chemical or physical or biological methods or methods of furthergoing treatment such as microsieves or sand filters.

Furthermore, three purification stations are, for example, combined with one another, with predominantly undissolved materials being removed in the first stage. Mechanical methods, occasionally supported by chemical supplementary agents, are used for this purpose.

Biological treatments are frequently used as the second stage with which organically dissolved materials can be removed to a large extent. A third stage can follow this second stage in which inorganically dissolved materials, for example eutrophicated phosphates, are separated by precipitation. If particularly high demands are made on the cleanliness of the water to be achieved, furthergoing purification stages are used which can be selected from the aforesaid methods.

In accordance with a further method known in the prior art for the treatment of water, the purification takes part in two stages, with the water being purified anaerobically in a first method step and aerobically in a step subsequent thereto. In the anaerobic purification, the organic materials are decomposed, in particular in water, using anaerobic microorganisms while forming biomass such as methane gas. The reduction of the organic freight in such a method step can amount to up to 80% of the COD value (chemical oxygen demand).

In the second state of such a treatment process, aerobic purification is preferably carried out in which atmospheric oxygen is supplied to the water (from the anaerobic stage). Such processes can, for example, be contact sludge processes or activated sludge processes in which the water is purified with microorganisms. The purification in such aerobic stages can amount to up to 60% of the COD value.

In addition to the reduction of the COD freight or BOD freight (biological oxygen demand), it may further be necessary under certain circumstances for the water to be purified to have high salt contents, in particular high degrees of hardness, in particular when it is a question of process waters in paper manufacture. In particular with critical production processes, a calcification of the production plant or an impairment of the production plant up to the failure of production can hereby result.

It can inter alia also be necessary for this reason to reduce or fully suppress the amount of water returned into the production circuit to prevent product downtimes or production problems. Furthermore, with a high degree of hardness, in particular with varying pH values of the process water in combination with piping routings and the process design (aeration through freefall), degassing processes of the water can take place which can in turn result in problems, substantial in part, in the manufacturing process and can have a negative effect on the quality of the product.

### SUMMARY

It is the underlying object of the present invention to provide an apparatus and a method for the treatment of water which, on the one hand, reduce the disadvantages known in the prior art at least in part, which are to be provided cost effectively and which are also in particular easy to integrate into existing plant.

This object is satisfied in accordance with the invention by an apparatus for the purification of water, in particular for the continuous purification of water in the paper industry. The object is furthermore also satisfied by a method for the purification of water.

Preferred embodiments of the apparatus in accordance with the invention or of the method in accordance with the invention are the subject of the dependent claims.

In accordance with the invention, the apparatus for the purification of water, in particular for the continuous purification of water in the paper industry, has at least one inflow for the water to be purified and at least one outflow for the purified water. The apparatus furthermore comprises at least one compression device for at least one part flow of the supplied water and furthermore an injection device for the injection of at least one gas into the water. At least the part flow, preferably the whole flow, of the water conducted in the apparatus is expanded in an expansion device, with the different phases of the water which arise in this process being separated from one another in an apparatus such that purified water can be removed from the plant. The expansion device can, in accordance with the present invention, be configured as a separate apparatus or also as an integrated apparatus, in particular within an apparatus downstream of the compression such as an activated sludge tank. The apparatus in accordance with the invention furthermore has at least one control system which detects at least one process parameter of the water or of the apparatus and controls at least the addition of at least one additive in dependence on the process parameter detected.

In accordance with the present invention, a liquid is understood as the water to be purified which can also have different solid proportions in addition to the dissolved proportions of different process components. The dissolved substances can per se be both solid substances, liquids and/or gases under room conditions, with the ratio of the different materials in the water being able to vary, even substantially in part, preferably in dependence on the predisposed process stage.

Such a water is inter alia also called waste water or process water, with these names substantially relating to the following utilization of the correspondingly purified water. For instance, waste waters are usually drained into a sewer system after purification and process water is returned to the manufacturing process.

A liquid is understood as purified water in accordance with the present invention in which a predetermined amount of solids, dissolved or organic and/or inorganic substances has been removed by means of a method or using an apparatus. The liquid treated in this way can be supplied to a subsequent process again as a suitable medium water or can also, e.g., be discharged into the sewer system, in the case of waste waters.

In accordance with the present invention, at least a part flow of the water amount introduced into the apparatus is compressed inside a compression device, for example by means of a pump and/or a valve, whereby in particular the pressure is considerably increased within this region. The pressure thus, for example, lies between 0.5 and 10 bar, preferably between 3 and 7 bar and particularly preferably between 5 and 6 bar. In accordance with the present invention, a predetermined amount of gas is supplied to this compressed water, preferably by means of an injection device, and is at least partly dissolved therein.

In accordance with a preferred embodiment, the gas is compressed air, with it also being in the sense of the present invention also to use other gases such as C0₂, in addition to air, which can in particular vary in their composition with respect to the individual components.

In accordance with the present invention, the invention device is a nozzle or a correspondingly designed outlet opening which ensures a distribution of the gas in the water flow which is as homogeneous as possible. Such injection devices are known from the prior art so that it is not necessary to look at them more closely at this point.

The compressed water with added gas is supplied to an expansion device in which the pressure of the gas/liquid mixture is substantially reduced, with this preferably taking place when the compressed part flow with added gas has already been combined with the further water.

This represents a preferred embodiment of the water guidance within the apparatus, with it being pointed out that it is naturally in the sense of the present invention only to treat a part flow of the water to be purified with the apparatus in accordance with the invention.

The expansion takes place in accordance with a particularly preferred embodiment of the present invention at least in one rest region of the apparatus, with the apparatus for the separation of the different phases of the water adjoining this rest region. Such an apparatus can, for example, be a flotation tank and/or sedimentation tank, with the floatant which is generated by the expansion of the water with added gas separating in the upper region. As is known in the prior art, materials are bound to these air bubbles and are discharged which are carried to the surface of the liquid by the bubble in dependence on their size and the specific weight or, if they are too heavy with the bound gas bubble or gas bubbles in relation to the buoyancy, sink to the bottom of the sedimentation region. For this reason, the present invention speaks of different phases which are composed, for example, of a mixture of gas bubbles with solids and a liquid proportion and are moved to the surface of the liquid column or to the bottom of the liquid column in dependence on the specific weight. The water purified of these materials is drained from the central region of the flotation/sedimentation container and e.g. supplied to a possible subsequent cleaning stage for utilization.

The apparatus in accordance with the invention furthermore has a control system for such a purification apparatus which detects at least one process parameter, preferably a plurality of process parameters, of the water and controls at least the addition of an additive in dependence on these process parameters.

Systems are understood as control systems in this connection which have a plurality of sensors for the determination of predetermined process parameters, in addition to a computer unit, and which inter alia use the information gained in this way for the monitoring, preferably for the controlling and/or feedback controlling of the process. For example, with the help of these process parameters, the addition of at least one additive into the water flow to be purified can thus be monitored, that is feed back controlled or controlled, with the apparatus in accordance with a particularly preferred embodiment having at least one metering point which permits the addition of a first additive before the expansion of the water flow.

The metering can take place, for example, when the compressed part flow with added gas has been supplied to the remaining water flow. The metering preferably takes place before the expansion of the compressed water with added gas.

In accordance with the present invention, auxiliary materials are understood as additives which are preferably selected from a group comprising, for example, cationic and anionic flocculants such as polyacrylamide, polyethylene imine, bentonite, water glass, polyamide amine, polyaluminum chloride, alum, starch, modified starch, carboxymethyl cellulose, mineral materials, glycosal, combinations thereof and the like, acids and/or bases, such as sodium lye, sodium aluminate, aluminum hydroxide, sulfuric acid, potash lye, organic acids and organic bases, reducing agents, oxidants, combinations thereof and the like. Furthermore waters, i.e. largely watery liquids, can be used as such additives which arise and are preferably subjected to an alkaline treatment in other processes, in particular in the waste water treatment and/or purification.

In accordance with the present invention, parameters are understood as the process parameters which are selected from a group which comprises, for example, the speed, the amount, the pressure, the temperature, the pH value, the proportion of cations, the proportion of anions, the proportion of organic substances, the proportion of solids, the viscosity, the surface tension, the charge state, the salt content, the hardness, reaction time, effect time, charge density, combinations thereof and the like.

In a further particularly preferred embodiment, at least one further purification apparatus is disposed upstream of the apparatus. As is known in the prior art, this can, for example, be a mechanical, a chemical and/or physical, a biological stage or a combination thereof and the like.

In accordance with a further particularly preferred embodiment, the inflow of the apparatus has a plurality of supply lines, that is a plurality of water flows, with at least some of the water conveyed therein being compressed and having a predetermined amount of gas added. In accordance with the above embodiment, the water flows are preferably combined in the following and subsequently supplied to an expansion and separation.

It is, however, naturally also in the sense of the present invention only to mix the compressed water flow with added gas or also only specific combinations of waste water flows with one another and to supply them for expansion and separation, that is for purification. It is furthermore also in the sense of the present invention that the compression or pressure increasing of the water flow takes place by the addition of the compressed gas.

It must furthermore be pointed out that the apparatus described above is also to be understood in its function or the method steps described in the following also cover the units or apparatus used herewith to be able to carry out the corresponding method steps. The methods also include the apparatus required therefor which are accordingly a part of the apparatus in accordance with the invention.

The object is also satisfied by the method in accordance with the invention for the purification of water, with the method in particular also being used for the continuous purification of water in the paper industry and comprising at least the compression of at least a part flow of the inflowing water in which at least one predetermined amount of a gas, in particular compressed air, is dissolved.

This compressed water flow in which a predetermined amount of gas is dissolved, is subsequently expanded, with fine bubbles hereby arising at which in particular solids of the water flow are bound.

As already stated with respect to the apparatus, the different phases can now be separated from one another, with the method in accordance with the invention being characterized in that at least one first additive is metered into the water flow after the compression in dependence on predetermined process parameters.

In accordance with a particularly preferred embodiment, only a part flow of the inflowing water is compressed and has gas added, with this water being mixed with the further water flow prior to the expansion. Subsequently, the water flow is expanded at a predetermined location, in particular in a rest region.

In accordance with a further particularly preferred embodiment, in the previously shown example, the metering of the at least first additive takes place after the mixing of the water with added gas and the other part flow or other part flows.

In accordance with a further preferred embodiment, the method is characterized in that at least some of the water flow which is supplied to the process was pretreated in at least one further purification stage. Such purification stages can, as known in the prior art, be mechanical, physical, anaerobic, aerobic purification stages and combinations thereof or the like.

It is furthermore also in the sense of the present invention that the compression and the dissolving of a gas take place in an inflowing water flow whose process parameters differ considerably from the process parameters of the water to be purified.

In accordance with a further particularly preferred embodiment, a second additive, which is preferably metered in dependence on predetermined process parameters, is metered to the water to be purified, preferably to the main water flow, before the compression or before the dissolving of a gas in the water.

It must further be pointed out that that naturally a plurality of additives can also be added to the water flow together or at different metering positions in order in particular to take account of the required reaction time of the individual auxiliary materials and also interactions of the additives.

In accordance with a further particularly preferred embodiment, the method in accordance with the invention is only used for a part flow of the water from an upstream purification stage, with it naturally also being in the sense of the present invention to treat the full flow of the water from an upstream purification stage with the method in accordance with the invention.

In accordance with a further preferred embodiment, the dissolving of the predetermined amount of gas takes place by means of an injection device under predetermined process conditions, with such injection devices being able to be, for example, nozzles or diffusers which in particular effect a uniform mixing of the water with the gas. Such injection devices are known in the prior art.

The invention is also further directed to the use of the aforesaid apparatus or of the aforesaid method for the purification of water, in particular for the continuous separation of salts, solids and/or gases from liquids, such as are used in the production process for the paper manufacture.

The invention will be explained in more detail in the following with reference to different embodiments, with it explicitly being pointed out that these are only some possible applications of the method in accordance with the invention or of the apparatus in accordance with the invention and that it is naturally also in the sense of the present invention to use the method and the apparatus in an alternative manner, in particular in different combinations. This means, for example, using the method or the apparatus in accordance with the invention for the purification of water such as forms the basis in other branches of industry which are, for example, dairies, the construction material industry, the metal-working and metal-producing industry, etc., or also in communal waste water purification.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a block diagram for the arrangement of the apparatus in accordance with the invention for the purification of water;

FIG. 2 is a further block diagram for the apparatus in accordance with the invention for the purification of a waste water;

FIG. 3 illustrates an alternative arrangement of the apparatus in accordance with the invention;

FIG. 4 illustrates a second alternative embodiment for the arrangement of the apparatus in accordance with the invention;

FIG. 5 illustrates a third alternative embodiment for the arrangement of the apparatus in accordance with the invention;

FIG. 6 illustrates a further alternative embodiment of the apparatus in accordance with the invention.

### DETAILED DESCRIPTION

The following description is merely exemplary in nature and is not intended to limit the present disclosure, application, or uses. It should be understood that throughout the drawings, corresponding reference numerals indicate like or corresponding parts and features.

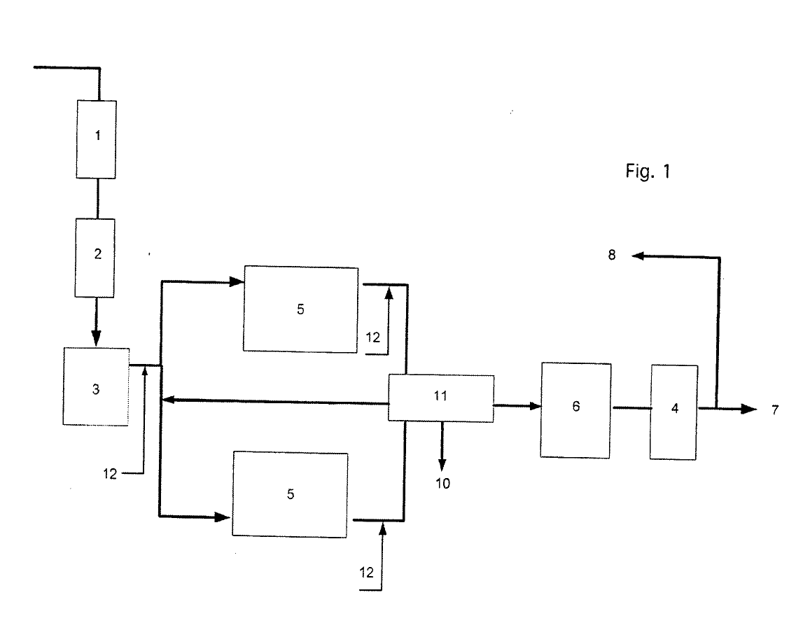

FIG. 1 shows, on the left hand side, the supply region of a water to be purified in which, for example, a combination of different apparatus can be arranged which effect the thickening or storage 1, a pre-purification 2 or a mixing and equalizing 3 of the water to be supplied. The apparatus 1, 2, 3 shown individually here can naturally also be combined with one another.

In accordance with the embodiment shown here, such a water has, in addition to the different accompanying substances, inter alia a degree of hardness of between 80 and 100° German hardness. This water is guided into a further presentation container (not shown) in which further water is supplied 12, in particular for the treatment, in order in particular to ensure a hydrodynamic consistency for the plant. The water to be purified is diluted in this process, with the degree of hardness, for example, hereby being reduced such that, in dependence on the dilution, it lies between 25° and 500° of German hardness, preferably between 25° and 80° dH, and particularly preferably between 40° and 80° dH. It is naturally also in the sense of the present invention that in particular the degree of hardness of the water can clearly deviate from the examples listed here.

This water is now supplied to a further pre-purification stage 5 which effects, for example with anaerobic process conditions, a reduction of constituents o the water. Other purification apparatus can naturally also be used, with the water thereby treated being supplied in accordance with the present invention either in the full flow or in the part flow of the apparatus 11 in accordance with the invention.

The accompanying substances carried out in this stage such as calcium compounds such as lime, gypsum, other alkaline earth compounds, COD freight or solids are preferably supplied to waste disposal 10 or are thickened in accordance with the known methods and then disposed of. Alternatively to this, the accompanying substances can also be used as a sedimentation aid for at least one biological purification stage, preferably for the activated sludge. It is also in the sense of the present invention that the accompanying substances carried out are supplied to a recycling, with this being able to take place, for example, by the use of the accompanying substances as loading materials for construction materials or the like.

The water purified in this manner is supplied via a presentation container to a further purification stage 6 which is used, for example, as aerobic biology for the further reduction of in particular the COD freight. In accordance with the embodiment shown here, the purified water is subsequently combined in an equilibrium bath 4 and returned, for example in a receiving stream 7 or into the production process 8.

In accordance with the invention, some of the purified water can also be moved back from the apparatus 11 into the treatment, i.e. in a circuit.

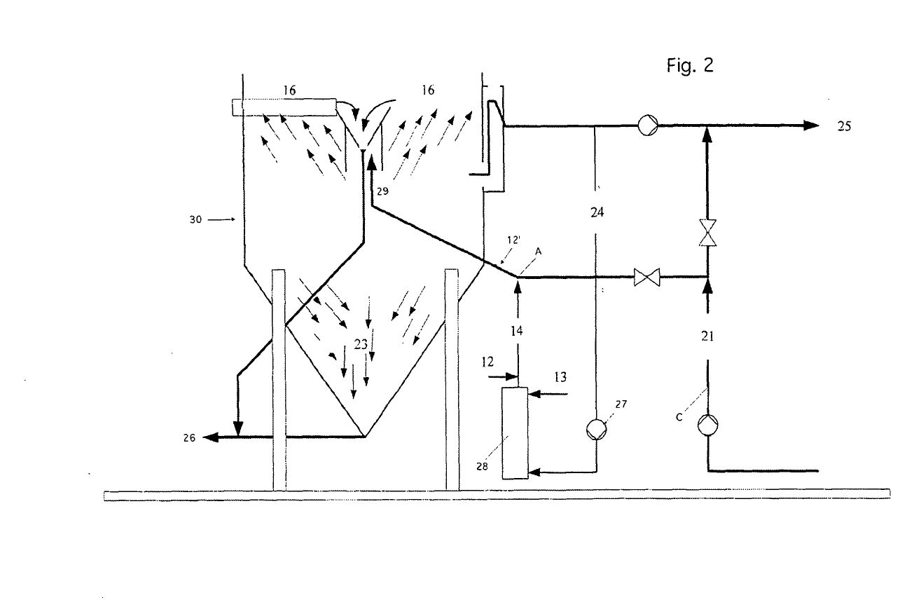

FIG. 2 now shows a possible installation of the apparatus in accordance with the invention in more detail in which a compressed water flow 14 saturated with air 13 is mixed to the main water flow 21.

As shown in this embodiment, purified water 25 is supplied via the line 24 to a pressure container via a pump 27 and is charged with air 13 in it. Subsequently, a first auxiliary material is metered in either at point 12 or 12′.

In this connection, in accordance with a particularly preferred embodiment, the pressures of the compressed water lie in the range between 2 and 10 bar, preferably between 3 and 7 bar and particularly preferably between 5 and 6 bar.

The mixing of the two water flows starts, in accordance with the embodiment shown here, in the position A, with particular measures having been taken under certain circumstances for the uniform mixing of the two flows. These can, for example, be a plurality of inlet openings which are applied to the periphery of the main line in order in particular to effect a uniform mixing of the two part flows.

Alternative methods such as are known in the prior art can also be used. In accordance with this embodiment, a first additive is further metered at the position 12, with, in accordance with a particularly preferred embodiment, a process parameter at the outlet 25 of the purified water being used as the feedback control type parameter. This can, for example, be the pH value, the solid proportion, the temperature, the charge state, the surface tension or the like.

In accordance with a particularly preferred embodiment, such an additive can preferably be an alkaline treated liquid whose pH value was set to a different value in another process. Such waters arise, for example, in the waste water purification or also in the purification in the paper industry such as in washers (wash waters) if these were treated in an alkaline manner, for example. These preferably alkaline treated waters can then preferably be used for the setting of at least one process parameter such as the pH value of the water to be purified.

The amount of additive is metered in at the point 12 in dependence on the guide parameters reached here. The pH value can, for example, thus be controlled by the metering of a base. The water prepared in this manner is guided into the rest region which, as shown here, is arranged inside a microflotation in which the expansion of the water flow takes place. The bubbles forming in this process carry at least some of the accompanying substances of the water as a floatant 16 to the water surface or, in the event that the buoyancy of the bubbles is insufficient, the suspended materials attached sink to the bottom of the container as sediment 23. Both the floatant and the sediment are removed and supplied, together or separately, for example in a thin sludge container 26, for further treatment or utilization.

The purified waste water 25 is drained off in the upper third of the container.

In accordance with a further particularly preferred embodiment, a further auxiliary material (second additive) is supplied to the main water flow at the positions C and/or D in order in particular to increase the size of the solid components in the waste water flow in the sense of a flocculation with aggregate formation before the adding of gas-saturated water to the main water flow by the addition of, for example, flocculating means in order thus to improve a subsequent treatment.

Due to this arrangement, in addition to the solids, dissolved components of the water can also be precipitated, with in particular calcium carbonate or magnesium carbonate being precipitated when the pH value exceeds a critical limit region or is directly guided to the critical limit region.

Furthermore, by the process management, in accordance with generally known chemical and physical laws, the solubility equilibrium can be displaced and thus the formation of precipitations be promoted, for example, by the setting of the pH value.

Furthermore, carbon dioxide is drained out of the water by the use of the expansion of a compressed water with added gas, whereby additionally a pH value displacement (increase) takes place. Furthermore, accompanying substances can also be oxidized by means of this process (e.g. reduced sulfur compounds such as could arise in an anaerobic reactor) and the oxidative conversion of odor-intensive material can thus also be effected.

Carbonates are thus inter alia drained off both with the floatant and with the sediment in addition to the solids by the method in accordance with the invention, with the water thus softened moreover being clearly liberated from organic freight. In particular characteristic values or parameters such as are known in the prior art as COD, BOD, ODS, organic acids and sulfur compounds are used for the evaluation of such a water.

The method can furthermore also be controlled such that the softening process and separation process is controlled using target values with suitable organic and/or inorganic polyelectrolytes, e.g. with corresponding absorption auxiliary means or adsorption auxiliary means. This can in particular also result in the desired results that a secure and cost effective plant is operated.

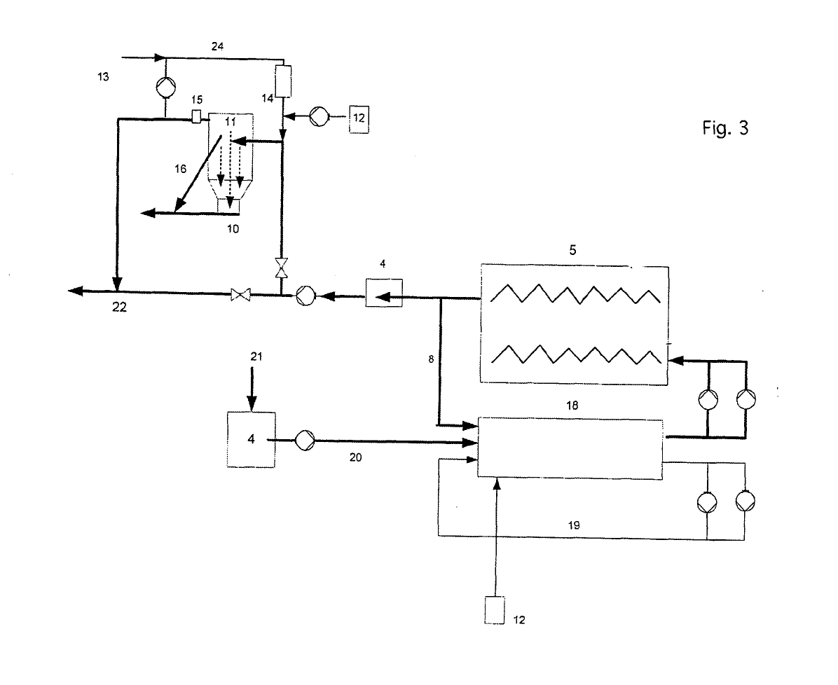

FIG. 3 shows a further alternative embodiment of the arrangement of the apparatus in accordance with the invention in a purification process, with here a part flow or a full flow of the outflow water from a pre-purification 5 being supplied to the purification apparatus via a presentation container 4, with only the metering point 12 for the first additive being shown in addition to the separation aggregate 11. In accordance with the apparatus in accordance with the invention and the method in accordance with the invention, the supplied water 24 has a predetermined amount of air 13 added before the metering of the additive and after it has left the pressure container 14.

The process shown in FIG. 3 furthermore shows that the supply flow is prepared in a predisposed purification stage 5, with the process procedure shown here relating to the purification of paper waste waters 21 which are treated after the setting of the pH value in 18 via the inlet line 12 in a first purification stage 5 which includes both mechanical and/or biological process steps. Some of the outflow of the first purification stage is returned with the arrow 8. The container 4 serves for the presentation of the water to be purified.

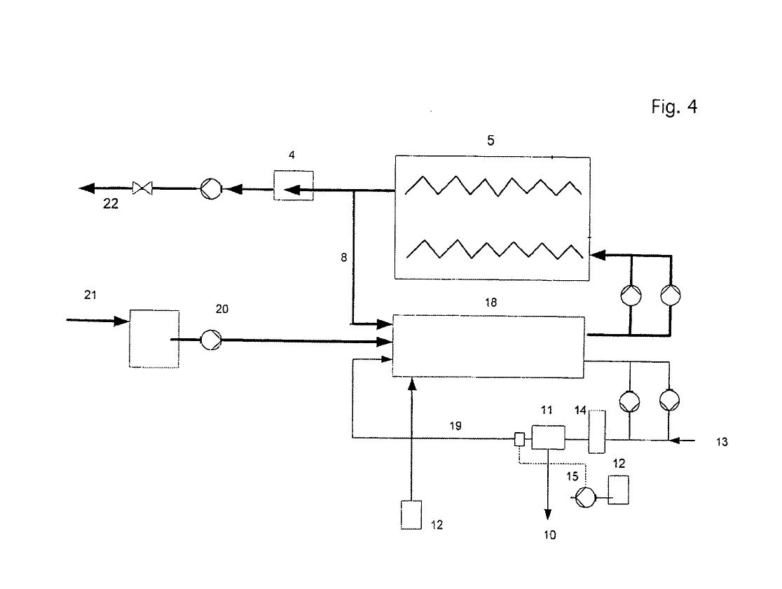

The alternative embodiment shown in FIG. 4 shows the apparatus in accordance with the invention in combination with a further purification device 5, with here the inflow being supplied directly from the paper waste water 21 to the purification stage 11 in accordance with the invention after the treatment or acidification 18. The water thus prepared is subsequently supplied to a further main purification step 5.

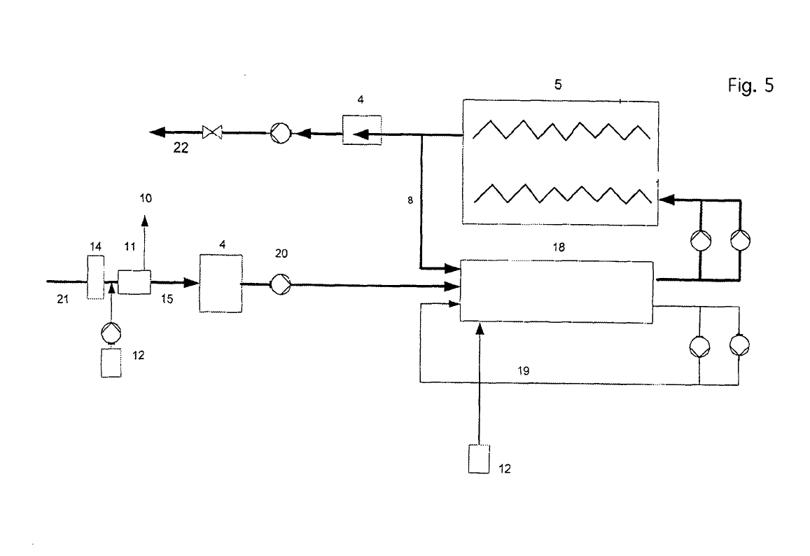

FIG. 5 shows a further alternative embodiment in which the water is already treated with the method 14/11 in accordance with the invention before the inflow into the treatment 18 or into the biological purification stage 5.

The water is thus already at least partly cleansed from accompanying substances such as lime and from organic freight before the treatment 3, 4, 5 so that soft water with a lower organic contamination is supplied to the biological stage in accordance with this embodiment.

In accordance with a further embodiment, not shown, the apparatus can naturally also be used independently for the preparation of water, with the problems caused by lime deposition in particular in the paper industry being able to be reduced or avoided.

In this connection, the waste water flow 21 is compressed and the gas 14 is added, at least one additive 12 is metered in and subsequently expanded and the phases are separated. The floatant and the sediment are removed over the drainage line 10 and the purified water is supplied to the presentation container 4. The water is supplied to the further purification stages via the inflow 20, with the water being able to be supplied via the drainage line 22 to further purification stages or to the receiving stream or being able to be returned to the process.

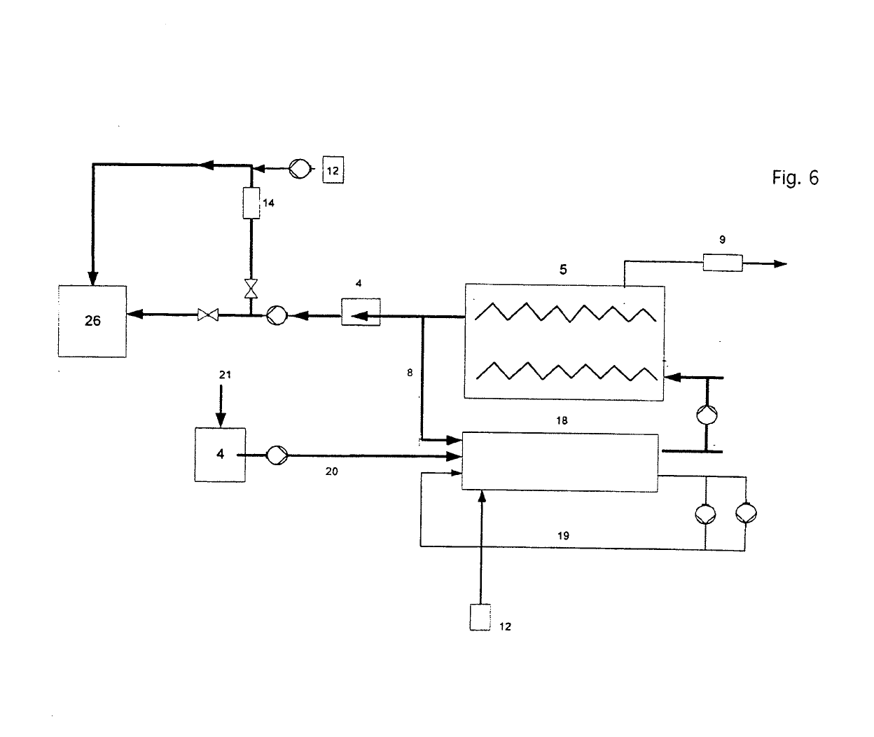

The embodiment shown in FIG. 6 of an apparatus in accordance with the invention is comparable with the embodiment of FIG. 3, with in contrast to this, the separation aggregate not being realized as an individual apparatus, but rather being integrated into an activation bath 26. This means that no independent microflotation is necessary, but is rather integrated in the region of the activation bath itself. In accordance with FIG. 3, the apparatus has a pressure container 14 to which at least some of the outflow water is supplied from the pre-purification 5. An auxiliary material is metered into this water after the pressure container via a metering point, in particular for the setting of a process parameter such as the pH value. Subsequent to this, the water to be purified is supplied to the activation bath.

The carry-out of the lime or of the lime compounds preferably takes place in this arrangement with the sediment of the activation bath so that the material separation takes place in the post-purification. In particular the costs for the apparatus and the installation costs can be further reduced thereby.

In addition to this arrangement, there is also shown in FIG. 6 at the anaerobic purification stage 5, the drainage line to the gas container 9 and the pellet store 17.

The description is merely exemplary in nature and, thus, variations that do not depart from the gist of the present disclosure are intended to be within the scope of the invention. Such variations are not to be regarded as a departure from the spirit and scope of the present disclosure.

### REFERENCE NUMBER LIST

1. thickening, general
2. pre-purification
3. equilibrium container
4. presentation container, general
5. ANAEROBICS
6. AEROBICS
7. process, biology
8. return, process, biology
9. gas container
10. lime carry-out
11. aggregate, lime trap
12. treatment, setting of the pH value
13. compressed air
14. process, air dispersion reactor
15. feedback control, pH value
16. floatant formation
17. pellet store
18. pre-acidification
19. circuit line, ring line
20. inflow ANAEROBICS
21. waste water, general
22. inflow, activated sludge plant
23. sediment
24. inflow, air dispersion reactor
25. outflow, lime trap
26. direct introduction, activation bath

1. An apparatus for the purification of water, in particular for the continuous purification of water in the paper industry, comprising
at least one inflow for the water and at least one outflow for the purified water,
a compression device (28) for at least one part flow of the water,
an injection device for the injection of at least one gas (12) into the water,
an expansion device (29) for the expansion of at least the part flow of the water, and
an apparatus for the separation (30) of different phases for the purification of the water,
wherein
the apparatus has at least one control system, which detects at least one process parameter of the water and controls at least the addition of at least one additive in dependence on the process parameter.

2. An apparatus in accordance with claim 1, wherein at least one further purification apparatus (5) is disposed before the apparatus.

3. An apparatus in accordance with claim 1, wherein the inflow (21) of the purification device has a plurality of supply lines, with the water conveyed therein in at least one (24/14) being thickened (28) and with a gas (13) being added in a predetermined amount.

4. An apparatus in accordance with claim 1, wherein at least one metering point (12) for at least one first additive is arranged after the combining of the individual water flows and before the expansion of the water.

5. A method for the purification of water, in particular for the continuous purification of water in the paper industry, comprising:
compression (28) of at least one part flow (24) of the inflowing water;
solution of a predetermined amount of gas (13) in the water;
expansion of the water flow (29);
separation of different phases of the water flow (30); and
metering at least one first additive (12, 12′) into the water flow after the compression in dependence on predetermined operating parameters.

6. A method in accordance with claim 5, wherein at least some of the water flow is pre-treated in at least one further purification stage (5).

7. A method in accordance with claim 5, wherein only a part flow (24) of the inflowing water flow is compressed.

8. A method in accordance with claim 5, wherein at least one second additive (C, D) is metered into the water, preferably into the main water flow, before the addition of the dissolved gas and/or of the gas to be dissolved in dependence on predetermined operating parameters in a predetermined ratio.

9. A method in accordance with claim 5, wherein the process parameters of the water are selected from a group of parameters which comprise the speed, the amount, the pressure, the temperature, the pH value, the proportion of cations and/or anions, the proportion of organic substances, the proportion of solids, the viscosity, the surface tension, the charge state (e.g. the zeta potential, charge demand, charge density), combinations thereof and the like.

10. A method in accordance with claim 5, wherein the additives are selected from a group of auxiliary materials which comprises cationic and anionic flocculation agents such as polyaluminum chloride, alum, polyethylene imine, bentonite, etc. and acids and/or bases such as sodium lye, sulfuric acid, potash lye, organic acids and organic bases, combinations thereof and the like.

11. A method in accordance with claim 5, wherein only a part flow of the water is supplied from an upstream purification stage to the purification method in accordance with at least one of the preceding claims.

12. A method in accordance with claim 5, wherein the full flow of the water is supplied from an upstream purification stage to the purification method in accordance with at least one of the preceding claims.

13. A method in accordance with claim 5, wherein the separation of the different phases of the water takes place in at least one rest zone after the expansion.

14. A method in accordance with claim 5, wherein the dissolving of a predetermined amount of gas takes place by means of an injection device under predetermined process conditions.

15. A method in accordance with claim 5, wherein at least some of the separated materials are supplied to a biological purification stage from the water to be purified.

16. Use of an apparatus in accordance with claim 1 for the purification of water, in particular for the continuous separation of salts and/or solids and/or gases from a liquid.
